(19) United States
(12) Patent Application Publication
(10) Pub. No.: US 2009/0288540 A1
(43) Pub. Date: Nov. 26, 2009

(54) Vertical band-saw

(76) Inventor: Roger Yeh, Paramount, CA (US)

Correspondence Address: POSZ LAW GROUP, PLC, 12040 SOUTH LAKES DRIVE, SUITE 101, RESTON, VA, 20191, US

(21) Appl. No.: 12/153,459

(22) Filed: May 20, 2008

(51) Int. Cl. B23D 53/00

(52) U.S. Cl. 83/788

(57) ABSTRACT

A vertical band-saw has a base, a conveyor assembly, an auxiliary pressing assembly, a band-saw assembly and an adjusting assembly. The base has two guide panels mounted on the base in alignment. The conveyor assembly is mounted on the base and has a front conveyor belt and a rear conveyor belt. The auxiliary pressing assembly is connected to the base above the conveyor assembly and has a top pressing wheel, a front lateral pressing wheel and a rear lateral pressing wheel. The band-saw assembly is movably connected to the base between the conveyor belts near the guide panels and has a casing, a drive motor and a band saw. The adjusting assembly is connected to the base to allow the band-saw assembly to be moved relative to the base simply and conveniently and has an actuating device, two driving screws and two bushing devices.

### BACKGROUND OF THE INVENTION

1. Field of the Invention

The present invention relates to a band-saw and more particularly to a vertical band-saw that can press an article stably and can be used conveniently.

2. Description of Related Art

With reference to FIG. 9, a conventional horizontal band-saw (90) is used to saw an article and has a base (91), a conveyor belt (92), a guide panel (93), two auxiliary pressing wheels (94) and a band-saw assembly (95). The conveyor belt (92) is horizontally mounted in the base (91). The guide panel (93) is formed on and protrudes from a sidewall of the base (91) near the conveyor belt (92) to abut and guide a side edge of the article. The auxiliary pressing wheels (94) are connected to the base (91) and extend above the conveyor belt (92) and each auxiliary pressing wheel (94) comprises a resilient element allowing the auxiliary pressing wheels (94) to press a top surface of the article with a pressing force. The band-saw assembly (95) is mounted in the base (91) and has two drive wheels (951) and a band saw (952). The drive wheels (951) are rotatably mounted in the base (91). The band saw (952) is mounted around the drive wheels (951) and has a top segment extended above the conveyor belt (92).

When sawing an article by the conventional horizontal band-saw (90), the article is placed on the conveyor belt (92) and the side edge of the article is pressed against the guide panel (93). The auxiliary pressing wheels (94) pressing on a top face of the article and the article is cut by the band saw (952) of the band-saw assembly (95).

However, the conventional horizontal band-saw (90) has the following defects and shortcomings.

1. The conventional horizontal band-saw (90) can provide different sawing position by moving the conveyor belt (92) up or down relative to the base (91) and the auxiliary pressing wheels (94) will move up or down by the resilient element to ensure contact with and press on the top face of the article. However, the pressing forces of the auxiliary pressing wheels (94) acting on the article are different when the conveyor belt (92) moves up or down, and this influences how the article is held on the conveyor belt (92).

2. The article must be pushed to ensure the side edge of the article remains in contact with the guide panel (93) when sawing the article and this is inconvenient. In addition, if the article is not pressed firmly against the guide panel (93) a processing quality of the article may be compromised.

To overcome the shortcomings, the present invention provides a vertical band-saw to mitigate or obviate the aforementioned problems.

### SUMMARY OF THE INVENTION

The main objective of the invention is to provide a vertical band-saw that can press an article stably and can be used conveniently.

The vertical band-saw in accordance with the present invention has a base, a conveyor assembly, an auxiliary pressing assembly, a band-saw assembly and an adjusting assembly. The base has two guide panels mounted on the base in alignment. The conveyor assembly is mounted on the base and has a front conveyor belt and a rear conveyor belt. The auxiliary pressing assembly is connected to the base above the conveyor assembly and has a top pressing wheel, a front lateral pressing wheel and a rear lateral pressing wheel. The band-saw assembly is movably connected to the base between the conveyor belts near the guide panels and has a casing, a drive motor and a band saw. The adjusting assembly is connected to the base to allow the band-saw assembly to be moved relative to the base easily and conveniently and has an actuating device, two driving screws and two bushing devices.

Other objects, advantages and novel features of the invention will become more apparent from the following detailed description when taken in conjunction with the accompanying drawings.

### BRIEF DESCRIPTION OF THE DRAWINGS

FIG. 1 is a rear perspective view of a vertical band-saw in accordance with the present invention;

FIG. 2 is an enlarged perspective view of a rail assembly of the vertical band-saw in FIG. 1, partially shown in phantom lines;

FIG. 3 is an enlarged rear perspective view of an auxiliary pressing assembly of the vertical band-saw in FIG. 1;

FIG. 4 is an operational rear perspective view of the vertical band-saw in FIG. 1;

FIG. 5 is an enlarged rear perspective view of an adjusting assembly of the vertical band-saw in FIG. 1;

FIG. 6 is an exploded perspective view of the adjusting assembly of the vertical band-saw in FIG. 5;

FIG. 7 is an enlarged rear view of the adjusting assembly of the vertical band-saw in FIG. 5;

FIG. 7A is an enlarged rear view of a bushing device of the adjusting assembly in FIG. 7;

FIG. 8 is an operational rear view of the vertical band-saw in FIG. 1; and

FIG. 9 is a perspective view of a horizontal band-saw in accordance with the prior art.

### DETAILED DESCRIPTION OF PREFERRED EMBODIMENT

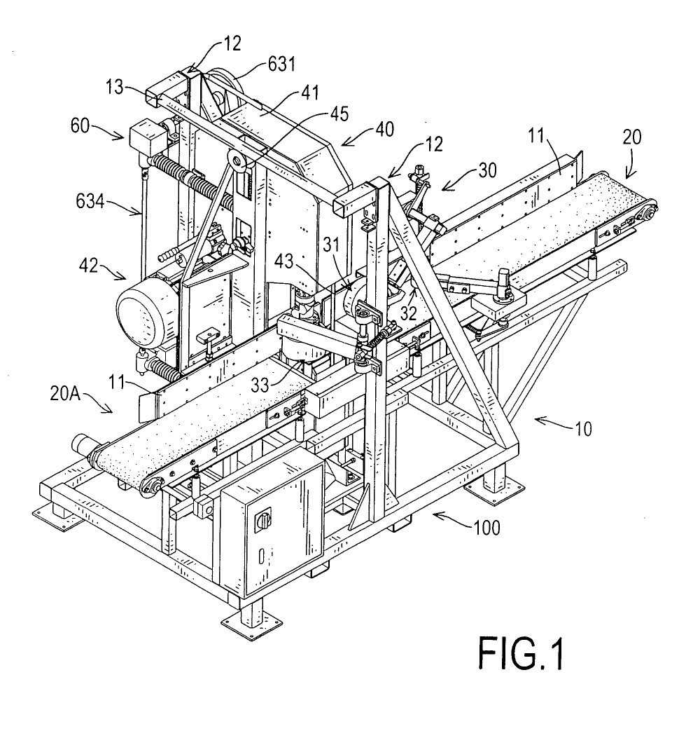

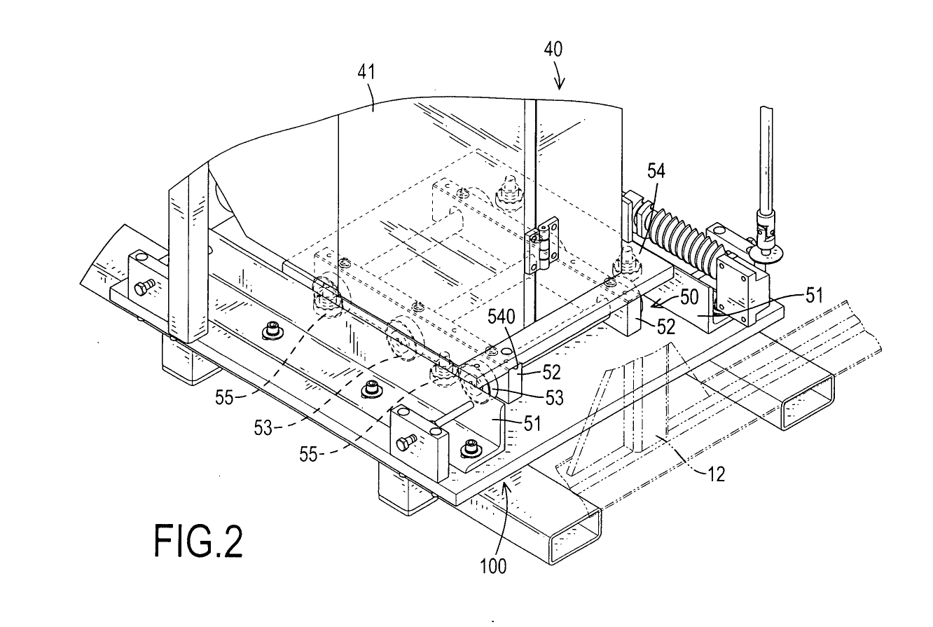

With reference to FIGS. 1 and 2, a vertical band-saw in accordance with the present invention has a base (10), a conveyor assembly, an auxiliary pressing assembly (30), a band-saw assembly (40) and an adjusting assembly (60).

The base (10) has a bottom, a front end, a rear end, a base frame (100), two supporting frames (12), two guide panels (11), a track (13) and a rail assembly (50). The base frame (100) is defined in the bottom of the base (10) and has a top face. The supporting frames (12) are mounted on and protrude from the top face of the base frame (100) near the front end of the base (10) and each supporting frame (12) has a top end. The guide panels (11) are mounted longitudinally on the base (10),may be on the base frame (100) in alignment between the supporting frames (12). The track (13) is connected between the top ends of the supporting frames (12) above and perpendicular to the guide panels (11).

The rail assembly (50) is mounted on the base fame (100) adjacent to one of the supporting frames (12) and has two outer rails (51), two inner rails (52) and a bottom panel (54).

The outer rails (51) are mounted on the bottom frame (100) parallel to the track (13) and each outer rail (51) has an internal face.

The inner rails (52) are mounted in the bottom frame (100) between the inner faces of the outer rails (51) and each inner rail (52) has an external face, a top edge and multiple inner wheels (53). The inner wheels (53) are rotatably mounted on the external faces of the inner rails (52) and contact the top face of the bottom frame (100).

The bottom panel (54) is movably mounted on the inner rails (52) and has a top, a bottom, two guiding grooves (540) and multiple outer wheels (55). The guiding grooves (540) are formed in the bottom of the bottom panel (54) and are respectively mounted on the top edges of the inner rails (52). The outer wheels (55) are rotatably mounted on the bottom of the bottom panel (54) and contact the internal faces of the outer rails (51).

The conveyor assembly is mounted on the base (10) above the rail assembly (50) and parallelly with the guide panels (11) and has a front conveyor belt (20) and a rear conveyor belt (20A). The front conveyor belt (20) is movably mounted in the front end of the base (10) between the supporting frames (12) and has two side edges. One of the side edges of the front conveyor belt (20) is next to one of the guide panels (11). The rear conveyor belt (20A) is movably mounted in the rear end of the base (10) parallel to the front conveyor belt (20) between the supporting frames (12) and has two side edges. One of the side edges of the rear conveyor belt (20A) is next to the other guide panel (11).

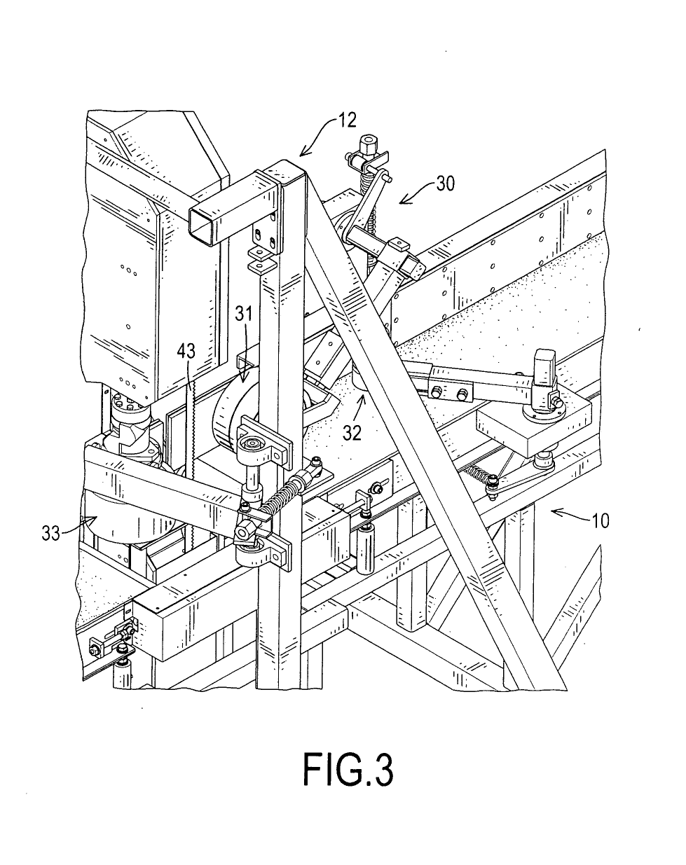

With further reference to FIG. 3, the auxiliary pressing assembly (30) is mounted on the base (10) above the conveyor assembly and has a top pressing wheel (31), a front lateral pressing wheel (32) and a rear lateral pressing wheel (33). The top pressing wheel (31) is connected to the base (10) above the front conveyor belt (20). The front lateral pressing panel (32) is connected to the base (10) near the other side edge of the front conveyor belt (20) opposite to a corresponding guide panel (11) and is disposed above the front conveyor belt (20). The rear lateral pressing wheel (33) is connected to the base (10) near the other side edge of the rear conveyor belt (20A) opposite to the other guide panel (11) that is away from the front conveyor belt (20) and is disposed above the rear conveyor belt (20A).

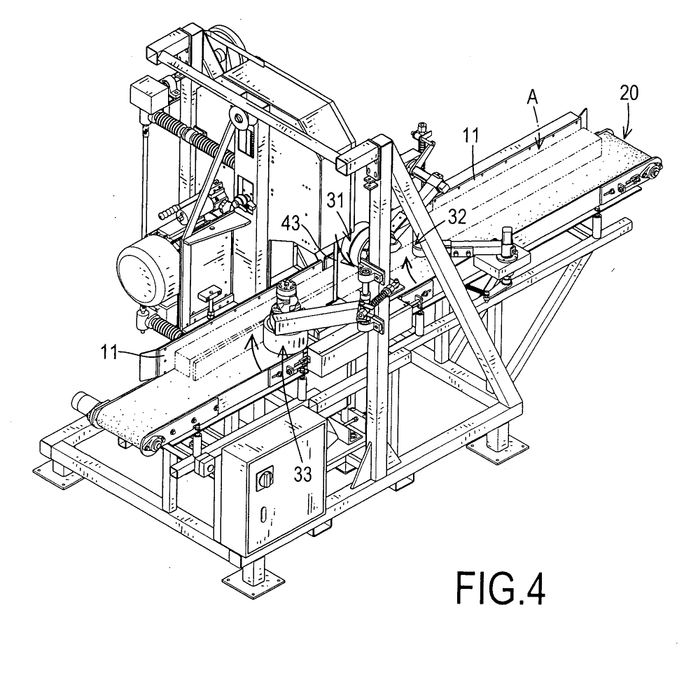

With further reference to FIG. 4, when an article (A) that has a top surface and two sidewalls is put on the conveyor assembly, the lateral pressing wheels (32, 33) and the top pressing wheel (31) are respectively pressed on one of the sidewalls and a top surface of the article (A) and push the other sidewall of the article (A) into contact with the guide panels (11). Then, the article (A) can be slidably held firmly on the conveyor assembly between the auxiliary pressing assembly (30) and the guide panels (11) of the base (10).

The band-saw assembly (40) is movably connected to the base (10) between the conveyor belts (20, 20A) of the conveyor assembly near the guide panels (11) below the top ends of the supporting frames (12) and has a casing (41), a drive motor (42), a band saw (43) and a roller (45).

The casing (41) is vertically mounted on the base (10), may be on the bottom panel (54) of the rail assembly (50) of the base (10) between the guide panels (11) and adjacent to one of the supporting frames (12) and has a rear side, a top end and a bottom end. The bottom end of the casing (41) is mounted on the base (10), may be mounted securely on the top of the bottom panel (54). Then, the casing (41) can be moved relative to the base (10) by the rail assembly (50) to adjust a cutting width of the vertical band-saw.

The drive motor (42) is mounted securely on the rear side of the casing (41) and may have two drive wheels rotatably mounted in the top end and the bottom end of the casing (41).

The band saw (43) being connected to the drive motor (42), may be mounted around the drive wheels of the drive motor (42) and extends out of the casing (41) between the conveyor belts (20, 20A) of the conveyor assembly to saw the article (A) on the conveyor belts (20, 20A) as shown in FIG. 4.

The roller (45) is rotatably mounted on the rear of the casing (41) above the drive motor (42) and is mounted on the track (13) of the base (10) between the supporting frames (12).

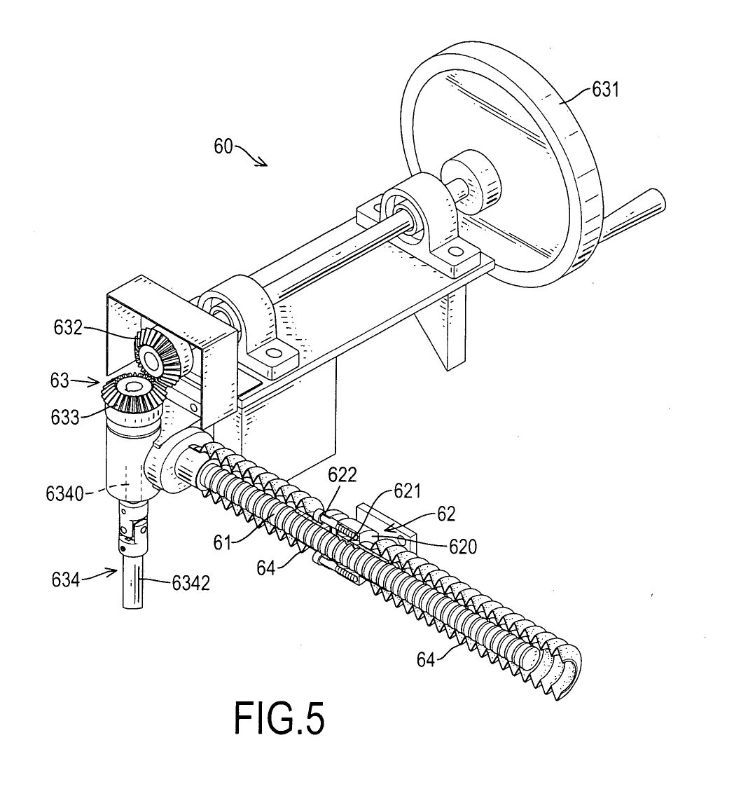

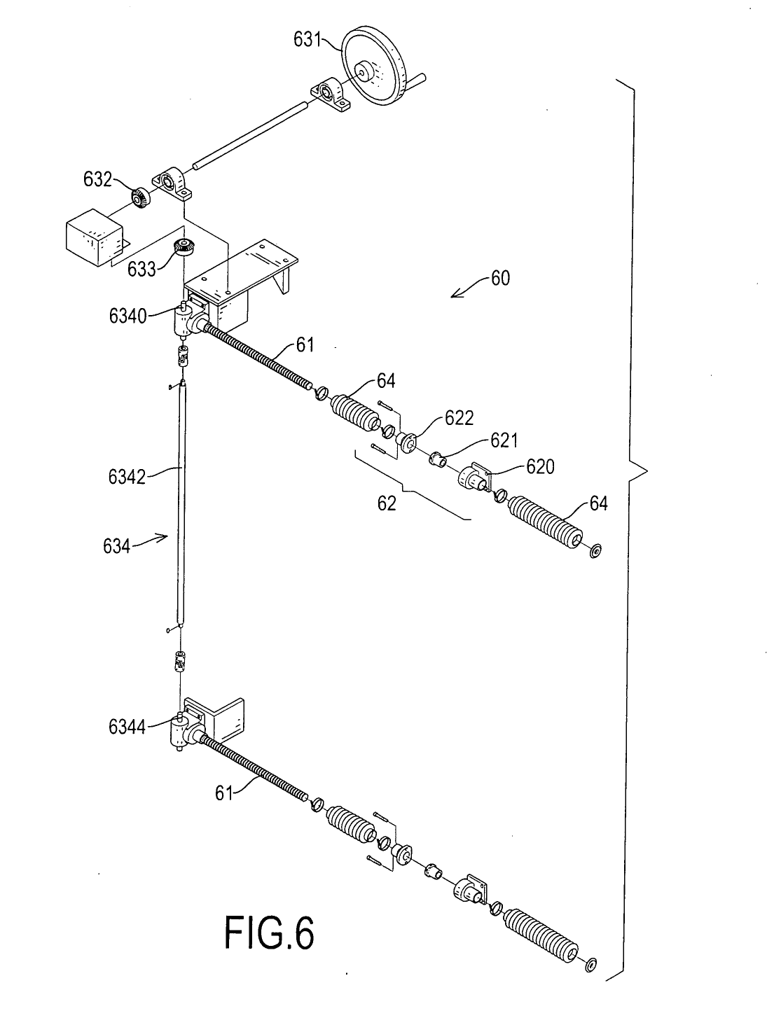

With further reference to FIGS. 5 to 7, the adjusting assembly (60) is connected to the base (10) to allow the band-saw assembly (40) to move relative to the base (10) and has an actuating device (63), at least one driving screw (61), at least one bushing device (62) and two dust covers (64).

The actuating device (63) is mounted on the base (10), near the casing (41), may be mounted on a corresponding supporting frame (12) and has a crank (631), two bevel gears (632, 633) and a transmitting axle (634). The crank (631) is rotatably mounted on the base (10), may be mounted rotatably on a corresponding supporting frame (12) near the top end and has a center and an extending shaft. The extending shaft is connected to the center of the crank (631) and has a connecting end. The bevel gears (632, 633) engage each other at right angles and a horizontal bevel gear (632) is mounted to the connecting end of the extending shaft of the crank (631). The transmitting axle (634) is connected to the other bevel gear (633) being a vertical bevel gear (633) and the transmitting axle (634) has an upper spindle (6340), a connecting shaft (6342) and a lower spindle (6344). The upper spindle (6340) is connected to the vertical bevel gear (633) and may have a steering pinion mounted in the upper spindle (6340). The connecting shaft (6342) is connected to the upper spindle (6340) and has an upper end, a lower end and two universal joints. The universal joints are respectively mounted on the upper end and the lower end of the connecting shaft (6342). The universal joint mounted on the upper end of the connecting shaft (6342) connects the upper end of the connecting shaft (6342) to the upper spindle (6340). The lower spindle (6344) is connected to the universal joint mounted on the lower end of the connecting shaft (6342) may have a steering pinion mounted in the lower spindle (6344).

The at least one driving screw (61) is connected to the casing (41), is connected to the actuating device (63), may be to the transmitting axle (634) of the actuating device (63) and the at least one driving screw (61) has an engaging end. When two driving screws (61) are implemented, the driving screws (61) are respectively mounted near the top end and the bottom end parallel to each other. The engaging end of the at least one driving screw (61) is connected to a corresponding spindle (6340, 6344), may be to the steering pinion of the corresponding spindle (6340, 6344). When the crank (631) is rotated, the at least one driving screw (61) is rotated with the spindles (6340, 6344) by the bevel gears (632, 633), the connecting shaft (6342) and the steering pinions of the spindles (6340, 6344).

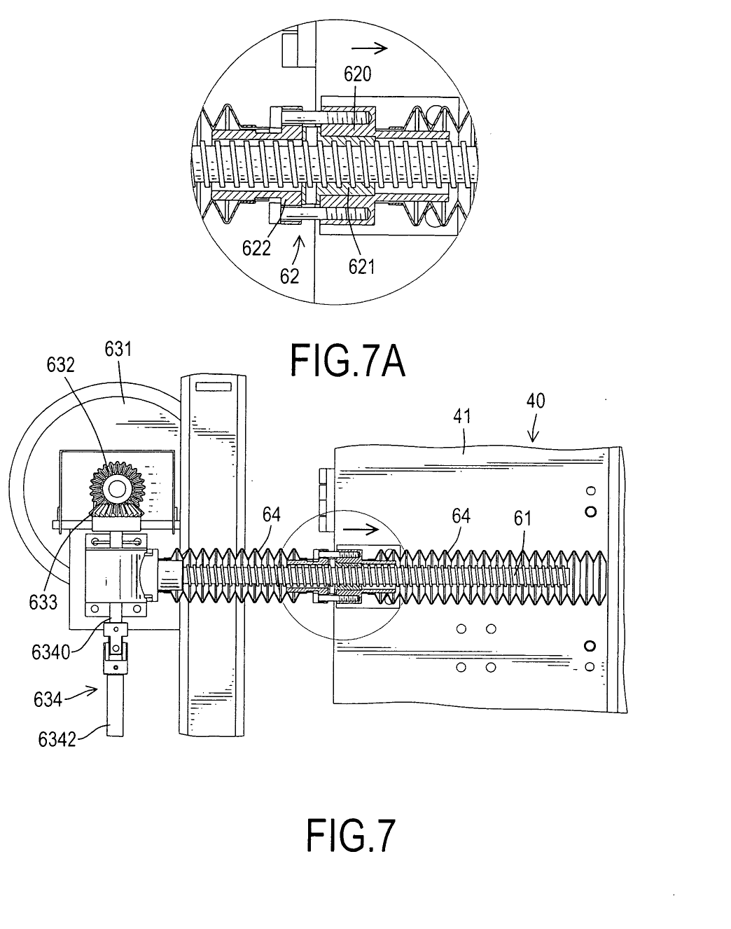

The at least one bushing device (62) is mounted on the casing (41), engages corresponding driving screw (61) and the at least one bushing device (62) has a mounting bracket (620), a screw bushing (621) and a holding cap (622). The mounting bracket (620) is mounted securely on a side of the casing (41), is aligned with a corresponding driving screw (61) and the mounting bracket (620) has a mounting hole. The screw bushing (621) is mounted securely in a corresponding mounting hole of a corresponding mounting bracket (620) and engages a corresponding driving screw (61). The holding cap (622) is connected to a corresponding mounting bracket (620) by multiple fasteners and is pressed against a corresponding screw bushing (621) to hold the screw bushing (621) on the corresponding mounting bracket (620) as shown in FIGS. 7 and 7A. The dust cover (64) is mounted around a corresponding driving screw (61) to prevent dust or saw dust from adhering to the driving screws (61).

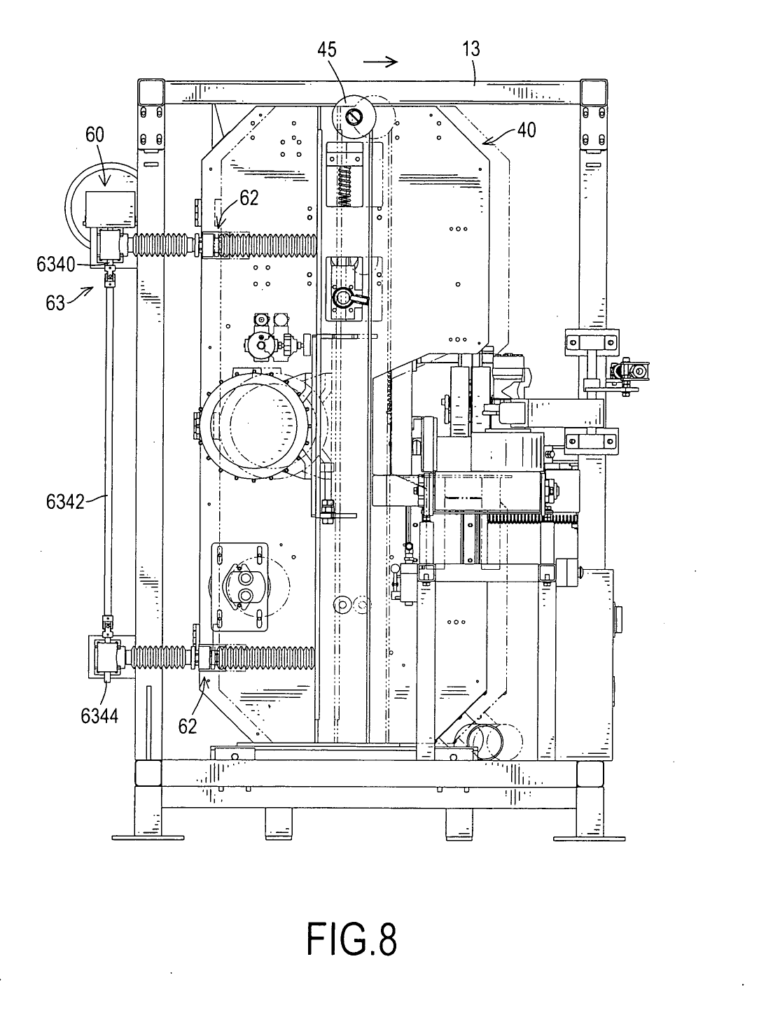

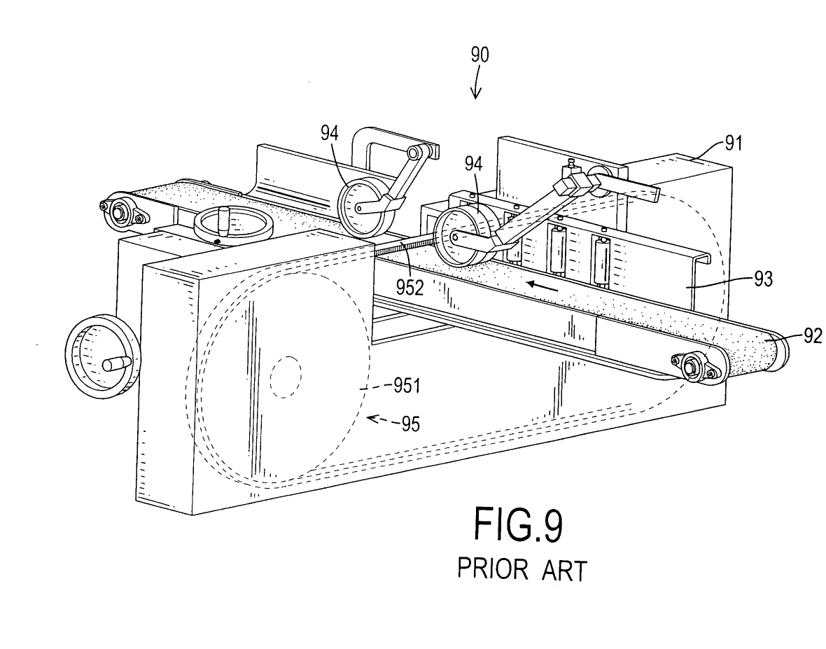

With further reference to FIG. 8, when the crank (631) is rotated, the bevel gears (632, 633) and the connecting shaft (6342) force the steering pinions mounted in the spindles (6340, 6344) to rotate, in turn forcing the at least one driving screw (61) to rotate causing the casing (41) to move with the at least one bushing device (62) along the rail assembly (50) relative to the base (10). When the casing (41) is moved relative to the base (10) by the adjusting assembly (60), the location of the band saw (43) relative to the guide panels (11) is altered. Therefore, adjusting a location of the band saw (43) provides different sawing dimensions by simple and convenient rotation of the crank (631).

Furthermore, when the articles (A) of various sizes are put on the conveyor belt (20, 20A), the pressing wheels (31, 32, 33) press the top surface and one of the sidewalls of the article (A) to slidably hold the article (A) stably on the conveyor assembly and to push the other sidewall of the article (A) against the guide panels (11) of the base (10). Then, the article (A) can be held on the conveyor assembly and pressed against the guide panels (11) without pushing the article (A) by hands when sawing the article (A), and this is convenient in use and can improve the processing quality of sawing the article (A).

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A vertical band-saw comprising
a base having
a bottom;
a front end;
a rear end; and
two guide panels being mounted on the base in alignment;
a conveyor assembly being mounted on the base parallelly with the guide panels and having
a front conveyor belt being movably mounted in the front end of the base and having two side edges, one of the side edges of the front conveyor belt being next to one of the guide panels; and
a rear conveyor belt being movably mounted in the rear end of the base parallel to the front conveyor belt and having two side edges, one of the side edges of the rear conveyor belt being next to the guide panel that is away from the front conveyor belt;
an auxiliary pressing assembly being mounted on the base above the conveyor assembly and having
a top pressing wheel being connected to the base above the front conveyor belt;
a front lateral pressing wheel being connected to the base near the side edge of the front conveyor belt opposite to a corresponding guide panel and being disposed above the front conveyor belt; and
a rear lateral pressing wheel being connected to the base near the side edge of the rear conveyor belt opposite to a corresponding guide panel and being disposed above the rear conveyor belt;
a band-saw assembly being movably connected to the base between the conveyor belts of the conveyor assembly near the guide panels and having
a casing being vertically mounted on the bottom of the base near the guide panels and having
a rear side;
a top end; and
a bottom end being mounted on the bottom of the base;
a drive motor being mounted securely on the rear side of the casing; and
a band saw being connected to the drive motor and extending out of the casing between the conveyor belts of the conveyor assembly; and
an adjusting assembly being connected to the base to allow the band-saw assembly to move relative to the base and having
an actuating device being mounted on the base near the casing;
at least one driving screw being connected to the casing and being connected to the actuating device; and
at least one bushing device being mounted on the casing and engaging respectively the at least one driving screw.

2. The vertical band-saw as claimed in claim 1, wherein the actuating device further has a crank being rotatably mounted on the base.

3. The vertical band-saw as claimed in claim 2, wherein
the adjusting assembly has
two driving screws being connected to the casing and the actuating device; and
two bushing devices being respectively mounted on the casing and respectively engaging the driving screws;
the crank of the actuating device has a center and an extending shaft being connected to the center of the crank and having a connecting end; and
the actuating device further has;
two bevel gears engaging each other at right angles and one of the bevel gears being a horizontal bevel gear being mounted to the connecting end of the extending shaft of the crank and the other bevel gear being a vertical bevel gear; and
a transmitting axle being connected to the vertical bevel gear.

4. The vertical band-saw as claimed in claim 3, wherein
the transmitting axle further has
an upper spindle being connected to the vertical bevel gear;
a connecting shaft being connected to the upper spindle and having
an upper end;
a lower end; and
two universal joints being respectively connected to the upper end and the lower end of the connecting shaft, the universal joint mounted on the upper end of the connecting shaft connecting the upper end of the connecting shaft to the upper spindle; and
a lower spindle being connected to the universal joint mounted on the lower end of the connecting shaft; and
each driving screw has an engaging end being connected to one of the spindles.

5. The vertical band-saw as claimed in claim 4, wherein each bushing device has
a mounting bracket being mounted securely on a side of the casing, being aligned with a corresponding driving screw and having a mounting hole;
a screw bushing being mounted securely in the mounting hole of the mounting bracket and engaging the corresponding driving screw; and
a holding cap being connected to the mounting bracket and being pressed against the screw bushing to hold the screw bushing on the mounting bracket.

6. The vertical band-saw as claimed in claim 5, wherein the adjusting assembly further has two dust covers being respectively mounted around the driving screws.

7. The vertical band-saw as claimed in claim 6, wherein
the base further has
a base frame being defined in the bottom of the base and having a top face;
two supporting frames being mounted on and protruding from the top face of the base frame near the front end of the base and each supporting frame having a top end;
a track being connected between the top ends of the supporting frames above and perpendicular to the guide panels; and
a rail assembly being mounted on the base fame adjacent to one of the supporting frames and having
two outer rails being mounted on the bottom frame parallel to the track and each outer rail having an internal face; and
two inner rails being mounted in the bottom frame between the inner faces of the outer rails and each inner rail having
an external face;
a top edge; and
multiple inner wheels being rotatably mounted on the external faces of the inner rails and contacting the top face of the bottom frame;
the actuating device is mounted on one of the supporting frames near the casing and the crank is rotatably mounted on a corresponding supporting frame near the top end.

8. The vertical band-saw as claimed in claim 7, wherein
the rail assembly further has a bottom panel being movably mounted on the inner rails and having
a top;
a bottom; and
two guiding grooves being formed in the bottom of the bottom panel and being respectively mounted on the top edges of the inner rails;
the bottom end of the casing is mounted securely on the top of the bottom panel.

9. The vertical band-saw as claimed in claim 8, wherein the bottom panel further has multiple outer wheels being rotatably mounted on the bottom of the bottom panel and contacting the internal faces of the outer rails.

10. The vertical band-saw as claimed in claim 9, wherein the band-saw assembly further has a roller being rotatably mounted on the rear of the casing above the drive motor and being mounted on the track of the base between the supporting frames.

11. The vertical band-saw as claimed in claim 1, wherein
the adjusting assembly has
two driving screws being connected to the casing and the actuating device; and
two bushing devices being respectively mounted on the casing and respectively engaging the driving screws;
the crank of the actuating device has a center and an extending shaft being connected to the center of the crank and having a connecting end; and
the actuating device further has;
two bevel gears engaging each other at right angles and one of the bevel gears being a horizontal bevel gear being mounted to the connecting end of the extending shaft of the crank and the other bevel gear being a vertical bevel gear; and
a transmitting axle being connected to the vertical bevel gear.

12. The vertical band-saw as claimed in claim 11, wherein
the transmitting axle further has
an upper spindle being connected to the vertical bevel gear;
a connecting shaft being connected to the upper spindle and having
an upper end;
a lower end; and
two universal joints being respectively connected to the upper end and the lower end of the connecting shaft, the universal joint mounted on the upper end of the connecting shaft connecting the upper end of the connecting shaft to the upper spindle; and
a lower spindle being connected to the universal joint mounted on the lower end of the connecting shaft; and
each driving screw has an engaging end being connected to one of the spindles.

13. The vertical band-saw as claimed in claim 1, wherein each bushing device has
a mounting bracket being mounted securely on a side of the casing, being aligned with a corresponding driving screw and having a mounting hole;
a screw bushing being mounted securely in the mounting hole of the mounting bracket and engaging the corresponding driving screw; and
a holding cap being connected to the mounting bracket and being pressed against the screw bushing to hold the screw bushing on the mounting bracket.

14. The vertical band-saw as claimed in claim 1, wherein the adjusting assembly further has two dust covers being respectively mounted around the driving screws.

15. The vertical band-saw as claimed in claim 1, wherein
the base further has
a base frame being defined in the bottom of the base and having a top face;
two supporting frames being mounted on and protruding from the top face of the base frame near the front end of the base and each supporting frame having a top end;
a track being connected between the top ends of the supporting frames above and perpendicular to the guide panels; and
a rail assembly being mounted on the base fame adjacent to one of the supporting frames and having
two outer rails being mounted on the bottom frame parallel to the track and each outer rail having an internal face; and
two inner rails being mounted in the bottom frame between the inner faces of the outer rails and each inner rail having
an external face;
a top edge; and
multiple inner wheels being rotatably mounted on the external faces of the inner rails and contacting the top face of the bottom frame;
the actuating device is mounted on one of the supporting frames near the casing and the crank is rotatably mounted on a corresponding supporting frame near the top end.

16. The vertical band-saw as claimed in claim 15, wherein
the rail assembly further has a bottom panel being movably mounted on the inner rails and having
a top;
a bottom; and
two guiding grooves being formed in the bottom of the bottom panel and being respectively mounted on the top edges of the inner rails;
the bottom end of the casing is mounted securely on the top of the bottom panel.

17. The vertical band-saw as claimed in claim 16, wherein the bottom panel further has multiple outer wheels being rotatably mounted on the bottom of the bottom panel and contacting the internal faces of the outer rails.

18. The vertical band-saw as claimed in claim 17, wherein the band-saw assembly further has a roller being rotatably mounted on the rear of the casing above the drive motor and being mounted on the track of the base between the supporting frames.
